(19) United States
(12) Patent Application Publication
(10) Pub. No.: US 2010/0050396 A1
(43) Pub. Date: Mar. 4, 2010

(54) Removable chock insert liner assembly

(76) Inventor: Garry Gates, Santa Barbara, CA (US)

Correspondence Address: LAW OFFICES OF ANDREW SCHROEDER, P.O. Box 6731, Santa Maria, CA, 93454, US

(21) Appl. No.: 12/231,715

(22) Filed: Sep. 4, 2008

(51) Int. Cl. F16G 11/00

(52) U.S. Cl. 24/115 R

(57) ABSTRACT

A Removable Chock Insert Liner Assembly to be affixed to a chock includes an α Insert Panel, a β Insert Panel, a Δ Insert Panel, an Ω Insert Panel, and a Bridge Member. The Bridge Member has an upper bridge surface, a lower bridge surface, an anterior end, a posterior end, a first slot and a second slot.

The α Insert Panel comprises an α upper surface, a α lower surface, an α first distal end, a α second distal end, an α pair of α first distal end slots, and a pair of α second distal end slots. The β Insert Panel comprises a β upper surface, a β lower surface, a β first distal end, a β second distal end, a pair of β first distal end slots, and a pair of β second distal end slots. The Δ Insert Panel comprises a Δ upper surface, a Δ lower surface, a Δ first distal end, a Δ second distal end, a pair of Δ first distal end slots, and Δ pair of Δ second distal end slots. The Ω Insert Panel comprises an Ω upper surface, an Ω lower surface, an Ω first distal end, an Ω second distal end, a pair of Ω first distal end slots, and a pair of Ω second distal end slots.

### FIELD OF THE INVENTION

The present invention relates with a system for use with marine vessels, and more particularly pertains to an apparatus for use with chocks.

### BACKGROUND OF THE INVENTION

One of the ways which marine and freshwater vessels station are stationed at various bays is through mooring lines. Generally speaking, mooring lines tether marine and freshwater vessels to docks by passing through chocks.

One of the inherent problems of mooring lines is that they weaken over time. The combination of the pit corrosive action on current chock technology by seawater and the constant strain and grinding of the mooring line with the chock creates an abrasive surface on the chock. As the mooring lines are abraded upon the surface of the chock, the mooring lines eventually must be replaced. The replacement of these mooring lines is expensive and can cost tens of thousands of dollars per large vessel per year. Moreover, weak mooring lines can pose a safety concern to passengers on board because if the mooring lines break, vast amounts of potential energy generated by the force of the ship during tidal action would be released and result in a serious safety risk to personnel and cargo in the general vicinity of the mooring line.

Therefore, what is clearly needed is an apparatus for the purpose of preserving the integrity of mooring lines. By preserving the integrity of mooring lines, substantial cost savings may redound to the owner of various large vessels. In addition, this apparatus may also decrease various safety hazards, which inhere with the weakening of mooring lines.

### SUMMARY OF THE INVENTION

It is an object of the present invention to provide an apparatus for the purpose of extending the product life of mooring lines. By providing a low friction-coefficient surface on a chock, which is impervious to the corrosive action of the sea environment, less abrasion will result to the mooring lines.

It is an object of the present invention to provide a system which can be used on preexisting chocks. Instead of replacing chocks on various vessels, the present invention may be used to quickly retrofit chocks already affixed to vessels.

It is an object of the present invention to create cost savings to owners of large vessels. By decreasing the frequency of mooring line replacement, substantial cost savings can redound to the benefit of the vessel owner.

It is also an object of the present invention to provide for an apparatus which can decrease the hazards associated with weakening mooring lines. By lessening the abrasion of mooring lines, safety hazards associated with weak mooring lines will decrease.

### BRIEF DESCRIPTION OF THE DRAWING FIGURES

FIG. 1A is a front elevation view of a preferred embodiment of the present invention.

FIG. 1B is a front elevation view of a preferred embodiment of the present invention.

FIG. 1C is a side elevation view of a preferred embodiment of the present invention.

FIG. 1D is a top elevation view of a preferred embodiment of the present invention.

FIG. 1E is a perspective view of a preferred embodiment of the present invention.

FIG. 1F is a perspective view of a preferred embodiment of the present invention.

FIG. 1G is a perspective view of a preferred embodiment of the present invention.

FIG. 1H is a perspective view of a preferred embodiment of the present invention.

FIG. 1I is a perspective view of a preferred embodiment of the present invention.

FIG. 1J is a perspective view of a preferred embodiment of the present invention.

FIG. 1K is a perspective view of a preferred embodiment of the present invention.

FIG. 1L is a perspective view of a preferred embodiment of the present invention.

FIG. 1M is a perspective view of a preferred embodiment of the present invention.

FIG. 1N is a plan view of a preferred embodiment of the present invention.

FIG. 1O is a side view of a preferred embodiment of the present invention.

FIG. 1P is a side view of a preferred embodiment of the present invention.

FIG. 1Q is a cross-sectional view of a preferred embodiment of the present invention.

FIG. 1R is a plan view of a preferred embodiment of the present invention.

FIG. 1S is a side view of a preferred embodiment of the present invention.

FIG. 1T is a side view of a preferred embodiment of the present invention.

FIG. 1U is a cross-sectional view of a preferred embodiment of the present invention.

FIG. 1V is a front elevation view of a preferred embodiment of the present invention.

FIG. 1W is a perspective view of a preferred embodiment of the present invention.

FIG. 2 is an exploded view of a preferred embodiment of the present invention.

FIG. 3 is an cross-sectional view of a preferred embodiment of the present invention.

FIG. 4 is a cross-sectional view of a preferred embodiment of the present invention.

FIG. 5 is a cross-sectional view of a preferred embodiment of the present invention.

FIG. 6 is a cross-sectional view of a preferred embodiment of the present invention.

FIG. 7 is an exploded view of a preferred embodiment of the present invention.

FIG. 8 is a perspective view of a preferred embodiment of the present invention.

FIG. 9 is a cross-sectional view of a preferred embodiment of the present invention.

FIG. 10A is a side view of a preferred embodiment of the present invention.

FIG. 10B is a plan view of a preferred embodiment of the present invention.

FIG. 11 is an assortment of views of a preferred embodiment of the present invention.

FIG. 12 is a perspective view of a preferred embodiment of the present invention.

FIG. 13 is a perspective view of a preferred embodiment of the present invention.

FIG. 14 is a front elevation view of a preferred embodiment of the present invention.

FIG. 15 is a perspective view of a preferred embodiment of the present invention.

### DESCRIPTION OF PREFERRED EMBODIMENTS

According to a preferred embodiment of the present invention, a unique apparatus is used to increase the life span of all mooring lines used in concert with chocks on large marine vessels and platforms. The apparatus and system is described in enabling detail below.

For the purpose of the present invention, a chock is shown as FIG. 175. This particular chock is known as a Panama Chock. Although a Panama Chock is illustrated, the present invention is adaptable for use with many different chocks commercially used. For the purposes of the present invention, the present invention should not be construed to be limiting to only Panama Chocks.

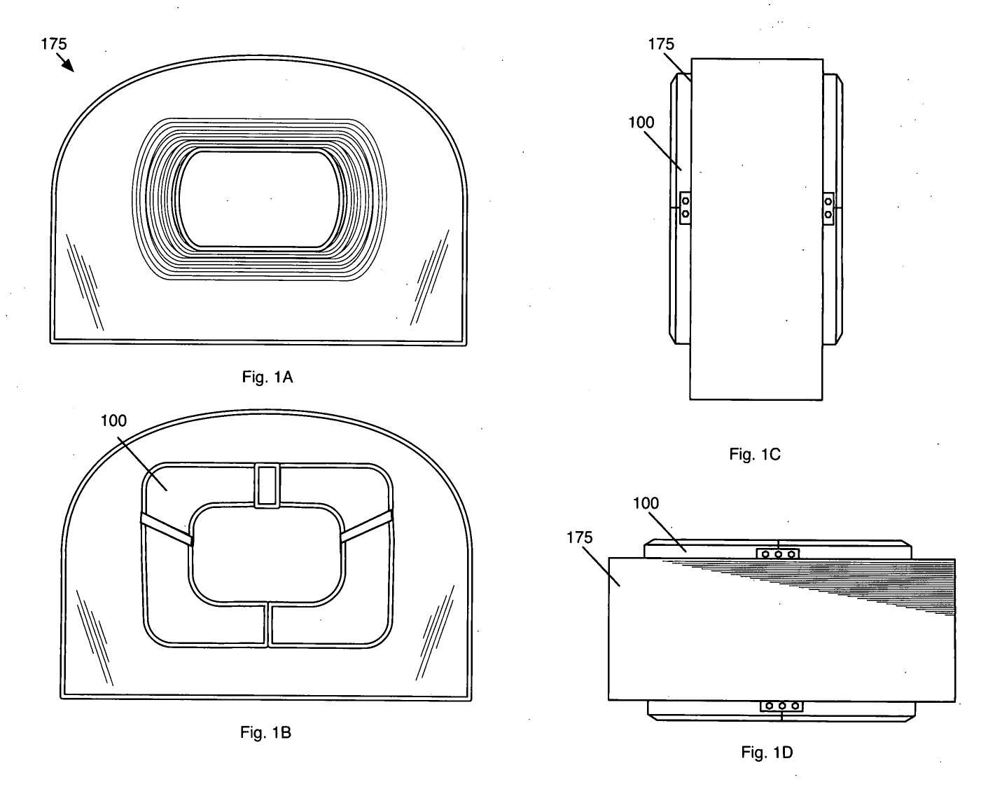

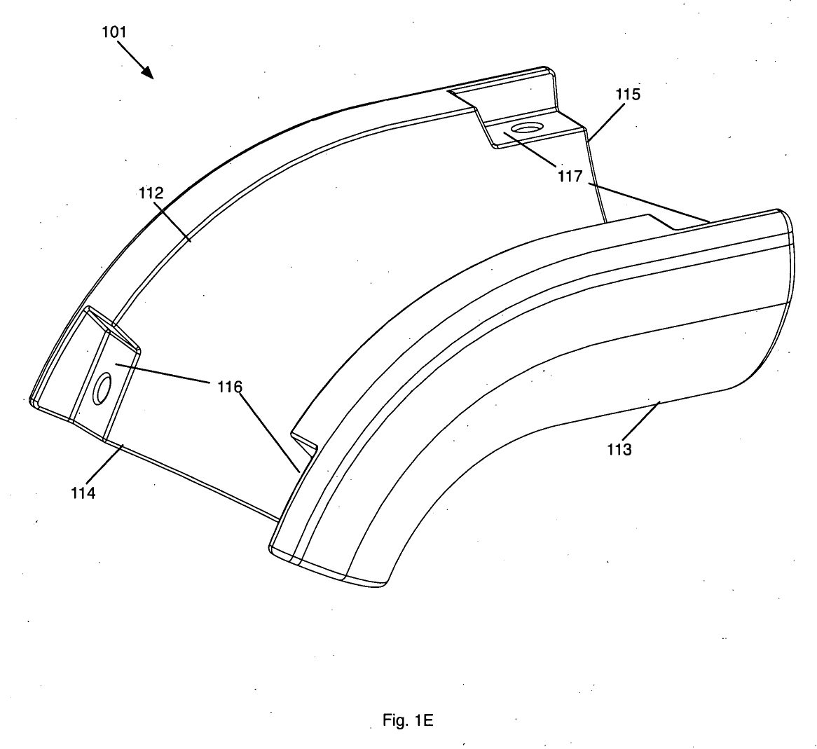

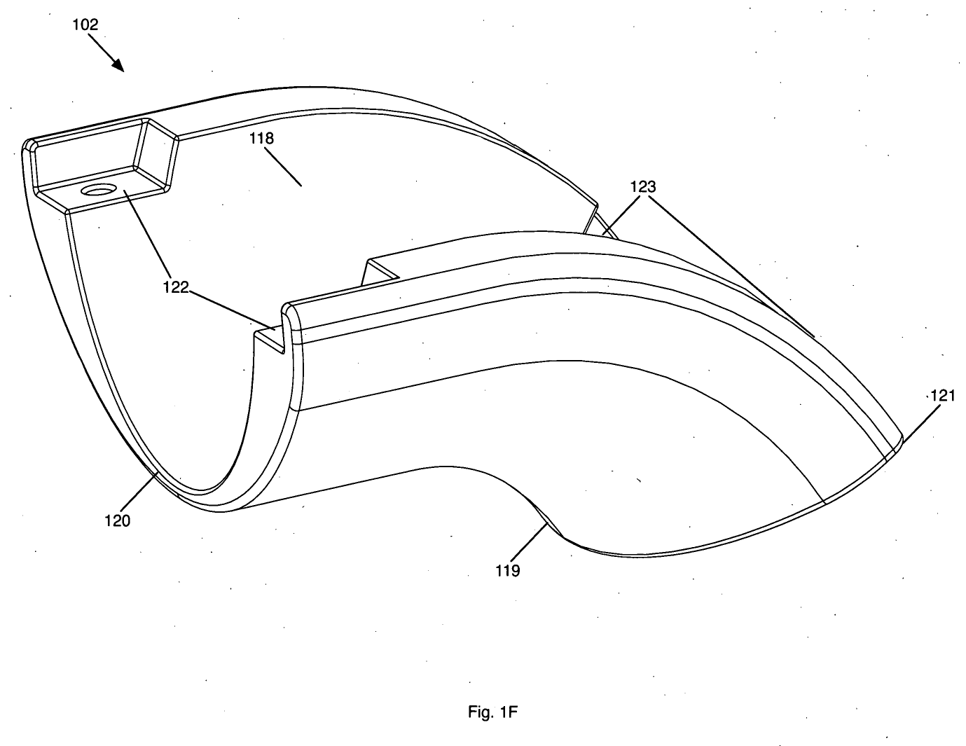

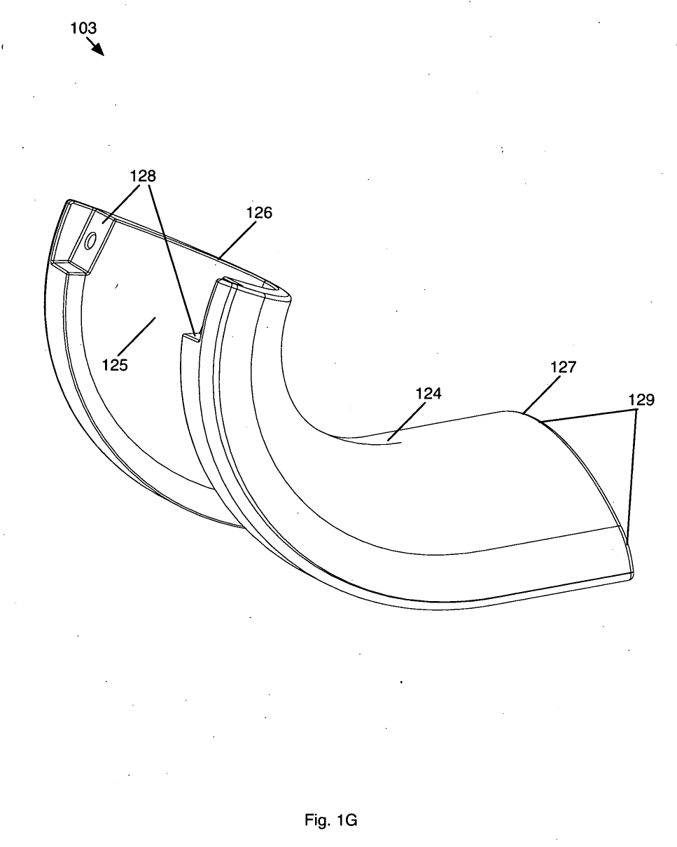

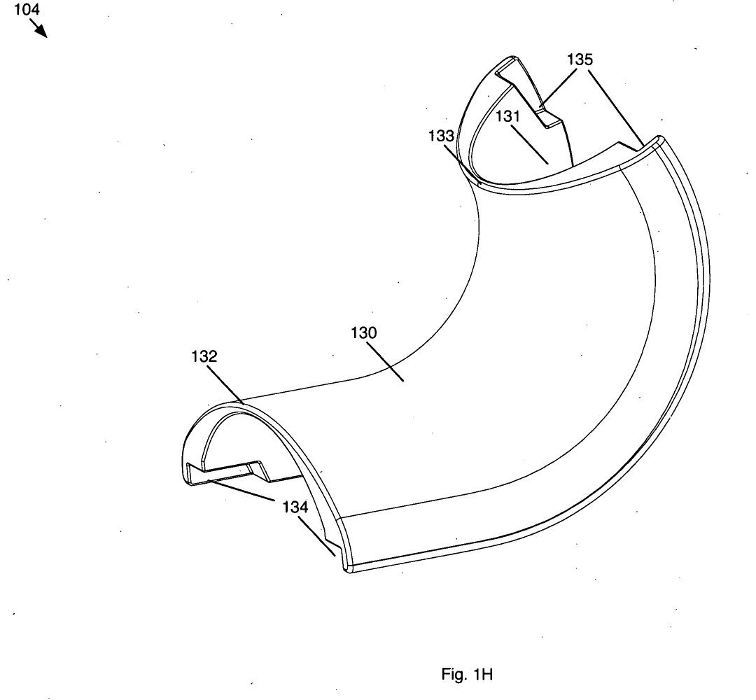

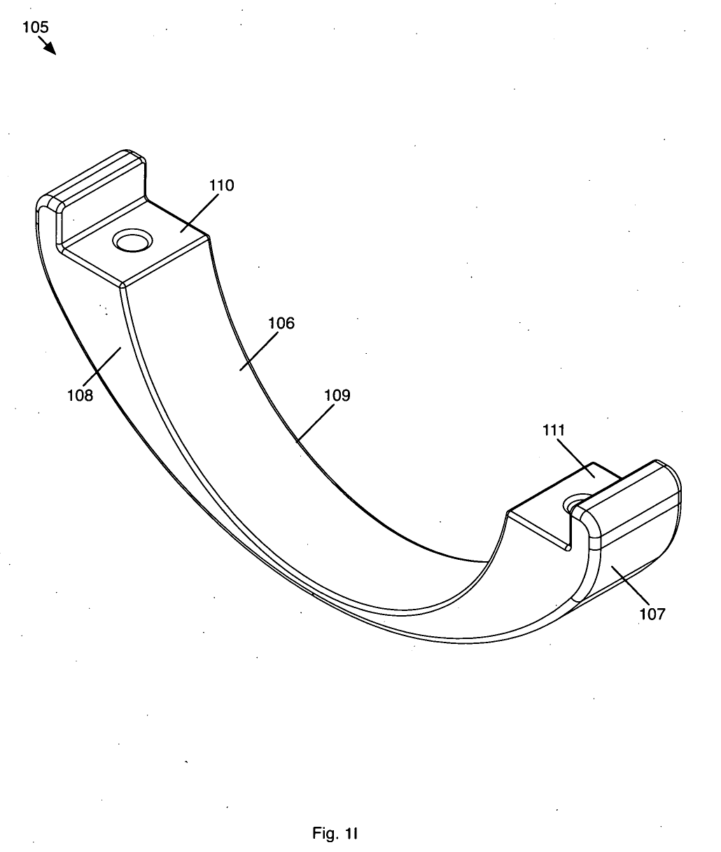

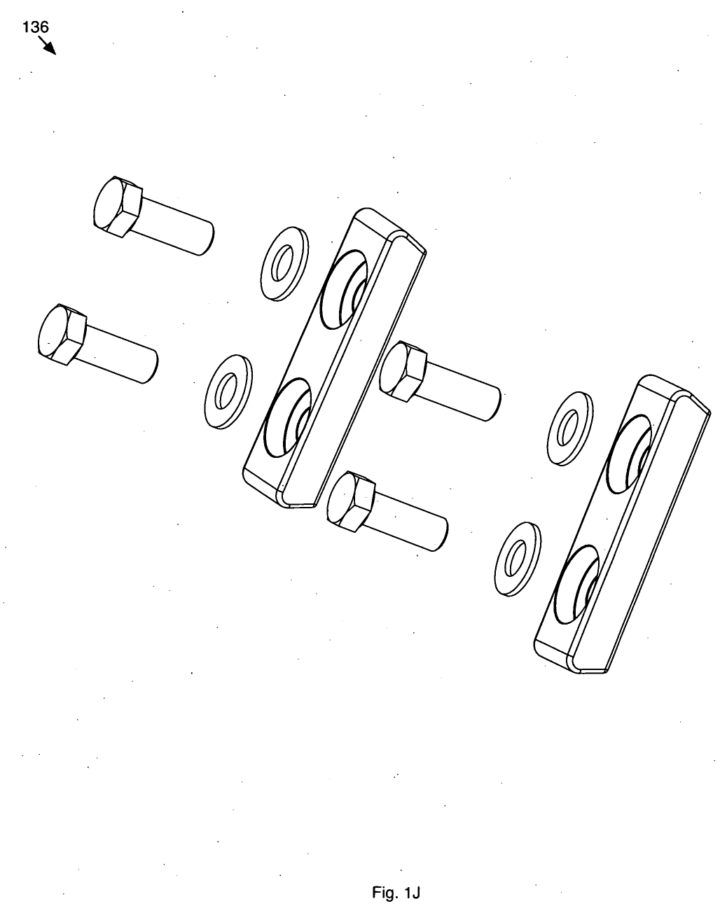

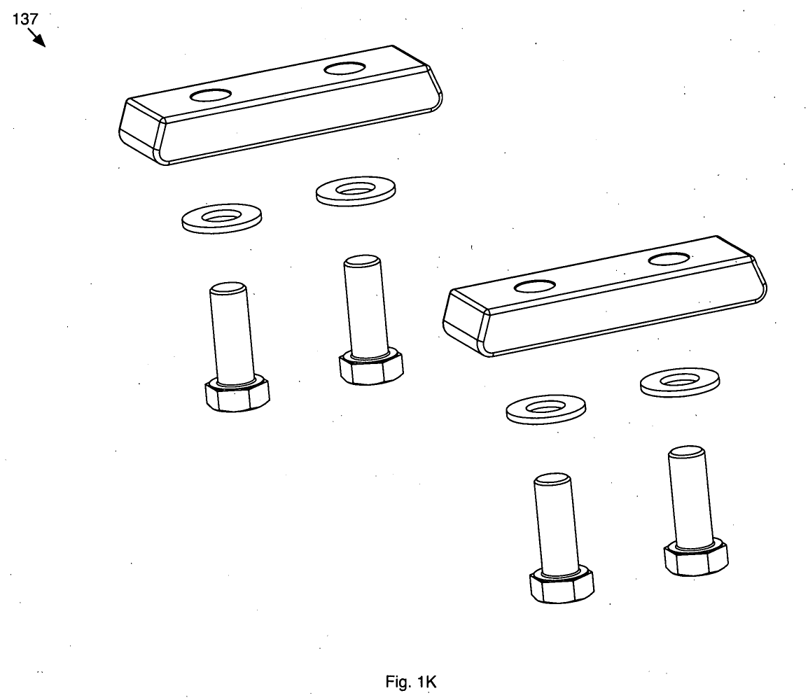

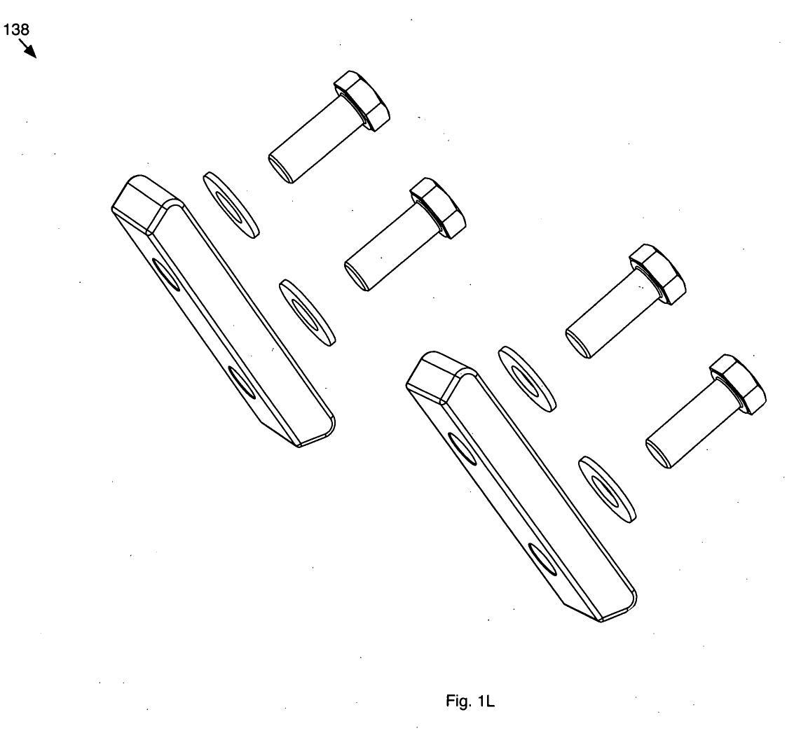

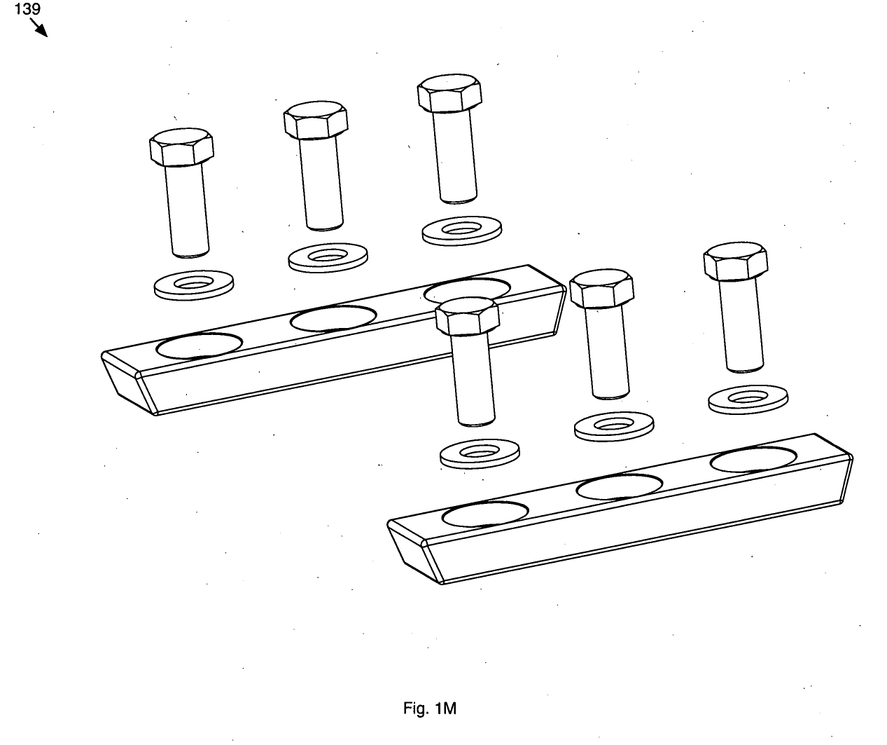

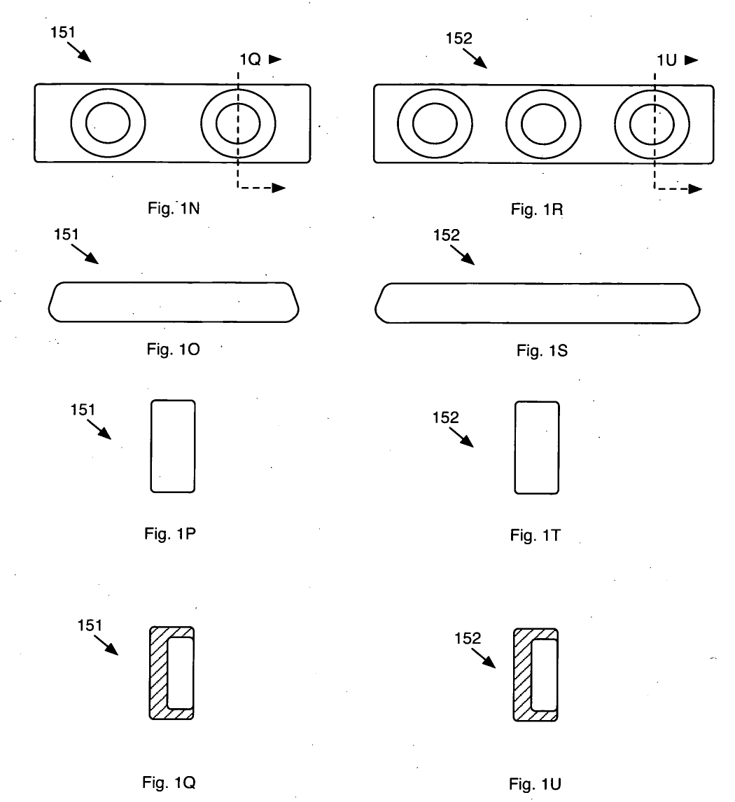

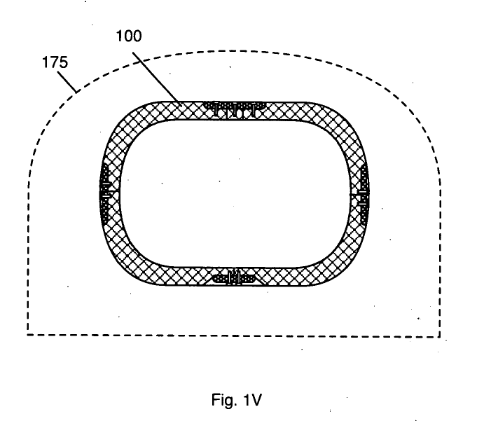

FIG. 1 illustrates a preferred embodiment of the present invention. A Removable Chock Insert Liner Assembly 100 to be affixed to a Chock 175 includes an α Insert Panel 101, a β Insert Panel 102, a Δ Insert Panel 103, an Ω Insert Panel 104, and a Bridge Member 105. The Removable Chock Insert Liner Assembly 100 is inserted into the Chock 175.

The Bridge Member 105 has an upper bridge surface 106, a lower bridge surface 107, an anterior end 108, a posterior end 109, a first slot 110 and a second slot 111.

The Bridge Member 105 may be comprised of a corrosion-resistant metal in some preferred embodiments. The corrosion-resistant metal may be either cast, forged, or stamped. Moreover, the Bridge Member 105 may be coated with a polymer sealant for the purpose of preventing rain and seawater infiltration. In addition, in some preferred embodiments, the Bridge Member 105 may be coated with a corrosion-resistant coating. Furthermore, in some preferred embodiments, it may be coated with a low friction-coefficient coating.

It is preferable that the coating possess an operating temperature of between −100° C. to 200° C. It is also preferable that the coating possess a Taber CS10 wheel abrasion of around 100 mg@25,000 cycles. Moreover, it is preferable that the coating have a hardness of around 60Rc min. Moreover, it is also preferable that the coating have a salt spray corrosion resistance greater than 1000 hours. It should be noted here that although the aforementioned preferred inherent properties of the coatings are desirable, the scope of the present invention should not be construed to specifically require coatings with all of the aforementioned properties.

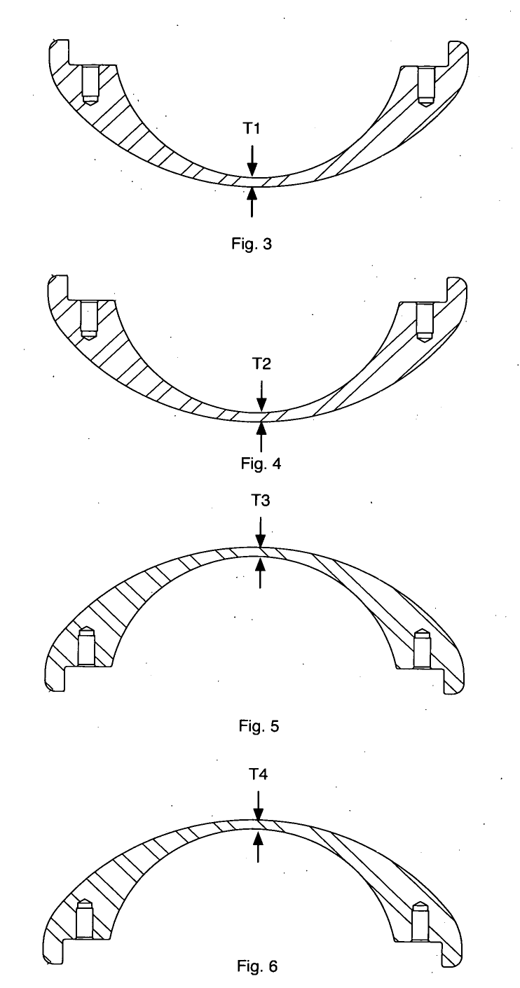

The α Insert Panel 101 comprises an α upper surface 112, a α lower surface 113, an α first distal end 114, a α second distal end 115, an α pair of a first distal end slots 116, and a pair of α second distal end slots 117. The upper surface, 112 of the α Insert Panel 101 is shaped to conform to a chock. In addition, the upper surface 112 of the α Insert Panel 101 may be coated with a low friction, anti-corrosion finish. FIG. 3 illustrates that the α Insert Panel 101 is tapered towards the center in order to maximize the opening of the Chock 175. The center has a thickness T1.

The α Insert Panel 101 may be comprised of a corrosion-resistant metal in some preferred embodiments. The corrosion-resistant metal may be either cast, forged, or stamped. Moreover, the α Insert Panel 101 may be coated with a polymer sealant for the purpose of preventing rain and seawater infiltration. In addition, in some preferred embodiments, the α Insert Panel 101 may be coated with a polymer sealant for the purpose of preventing rain and seawater infiltration. In addition, in some preferred embodiments, the α Insert Panel 101 may be coated with a corrosion-resistant coating. Furthermore, in some preferred embodiments, it may be coated with a low friction-coefficient coating.

It is preferable that the coating possess an operating temperature of between −100° C. to 200° C. It is also preferable that the coating possess a Taber CS10 wheel abrasion of around 100 mg@25,000 cycles. Moreover, it is preferable that the coating have a hardness of around 60Rc min. Moreover, it is also preferable that the coating have a salt spray corrosion resistance greater than 1000 hours. It should be noted here that although the aforementioned preferred inherent properties of the coatings are desirable, the scope of the present invention should not be construed to specifically require coatings with all of the aforementioned properties.

The β Insert Panel 102 comprises a β upper surface 118, a β lower surface 119, a β first distal end 120, a β second distal end 121, a pair of β first distal end slots 122, and a pair of β second distal end slots 123. The upper surface 118 of the β Insert Panel 102 is shaped to conform to a chock. In addition, the upper surface 118 of the β Insert Panel 102 may be coated with a low friction, anti-corrosion finish. FIG. 4 illustrates that the β Insert Panel 102 is tapered towards the center in order to maximize the surface radius of the chock. By increasing the surface radius of the chock, there will be less sharp bending of the mooring lines. The center has a thickness T2.

The β Insert Panel 102 may be comprised of a corrosion-resistant metal in some preferred embodiments. The corrosion-resistant metal may be either cast, forged, or stamped. Moreover, the β Insert Panel 102 may be coated with a polymer sealant for the purpose of preventing rain and seawater infiltration. In addition, in some preferred embodiments, the β Insert Panel 102 may be coated with a corrosion-resistant coating. Furthermore, in some preferred embodiments, it may be coated with a low friction-coefficient coating.

It is preferable that the coating possess an operating temperature of between −100° C. to 20° C.; It is also preferable that the coating possess a Taber CS10 wheel abrasion of around 100 mg@25,000 cycles. Moreover, it is preferable that the coating have a hardness of around 60Rc min. Moreover, it is also preferable that the coating have a salt spray corrosion resistance greater than 1000 hours. It should be noted here that although the aforementioned preferred inherent properties of the coatings are desirable, the scope of the present invention should not be construed to specifically require coatings with all of the aforementioned properties.

The Δ Insert Panel 103 comprises a Δ upper surface 124, a Δ lower surface 125, a Δ first distal end 126, a Δ second distal end 127, a pair of Δ first distal end slots 128, and a pair of Δ second distal end slots 129. The lower surface 125 of the Δ Insert Panel 103 is shaped to conform to a chock. In addition, the lower surface 125 of the Δ Insert Panel 103 may be coated with a low friction, anti-corrosion finish. FIG. 5 illustrates that the Δ Insert Panel 103 is tapered towards the center in order to maximize the opening of the chock. The center has a thickness T3.

The Δ Insert Panel 103 may be comprised of a corrosion-resistant metal in some preferred embodiments. The corrosion-resistant metal may be either cast, forged, or stamped. Moreover, the Δ Insert Panel 103 may be coated with a polymer sealant for the purpose of preventing rain and seawater infiltration. In addition, in some preferred embodiments, the Δ Insert Panel 103 may be coated with a corrosion-resistant coating. Furthermore, in some preferred embodiments, it may be coated with a low friction-coefficient coating.

It is preferable that the coating possess an operating temperature of between −100° C. to 200° C. It is also preferable that the coating possess a Taber CS10 wheel abrasion of around 100 mg@25,000 cycles. Moreover, it is preferable that the coating have a hardness of around 60Rc min. Moreover, it is also preferable that the coating have a salt spray corrosion resistance greater than 1000 hours. It should be noted here that although the aforementioned preferred inherent properties of the coatings are desirable, the scope of the present invention should not be construed to specifically require coatings with all of the aforementioned properties.

The Ω Insert Panel 104 comprises an Ω upper surface 130, an Ω lower surface 131, an Ω first distal end 132, an Ω second distal end 133, a pair of Ω first distal end slots 134, and a pair of Ω second distal end slots 135. The lower surface 131 of the Ω Insert Panel 104 is shaped to conform to a chock. In addition, the lower surface 131 of the Ω Insert Panel 104 may be coated with a low friction, anti-corrosion finish. FIG. 6 illustrates that the Ω Insert Panel 104 is tapered towards the center in order to maximize the opening of the chock. The center has a thickness T4.

The Ω Insert Panel 104 may be comprised of a corrosion-resistant metal in some preferred embodiments. The corrosion-resistant metal may be either cast, forged, or stamped. Moreover, the Ω Insert Panel 104 may be coated with a polymer sealant for the purpose of preventing rain and seawater infiltration. In addition, in some preferred embodiments, the Ω Insert Panel 104 may be coated with a corrosion-resistant coating. Furthermore, in some preferred embodiments, it may be coated with a low friction-coefficient coating.

It is preferable that the coating possess an operating temperature of between −100° C. to 200° C. It is also preferable that the coating possess a Taber CS10 wheel abrasion of around 100 mg@25,000 cycles. Moreover, it is preferable that the coating have a hardness of around 60Rc min. Moreover, it is also preferable that the coating have a salt spray corrosion resistance greater than 1000 hours. It should be noted here that although the aforementioned preferred inherent properties of the coatings are desirable, the scope of the present invention should not be construed to specifically require coatings with all of the aforementioned properties.

The α Insert Panel 101 is connected with the Δ Insert Panel 103 at the α first distal end 114 of the α Insert Panel 101 and the Δ second distal end 126 of the Δ Insert Panel 103. The Δ Insert Panel 103 is connected with the Ω Insert Panel 104 at the Δ first distal end 127 of the Δ Insert Panel 103 and the Ω second distal end 132 of the Ω Insert Panel 104. The Ω Insert Panel 104 is connected with the β Insert Panel 102 at the Ω first distal end 133 of Ω Insert Panel 104 and the β second distal end 121 of the β Insert Panel 102. The α Insert Panel 101 is connected with the Bridge Member 105 at the anterior end 108. The β Insert Panel 102 is connected with the Bridge Member 105 at the posterior end 109.

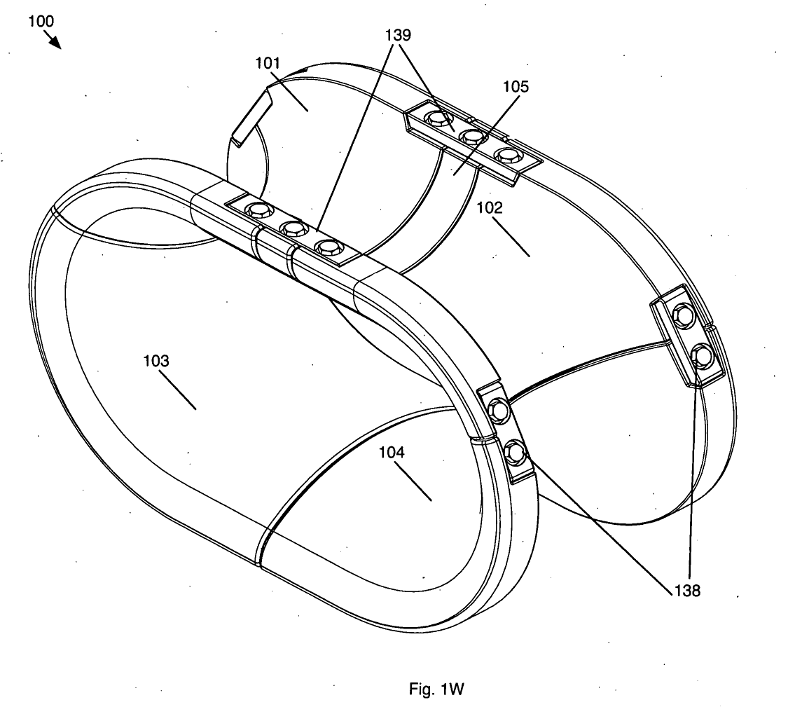

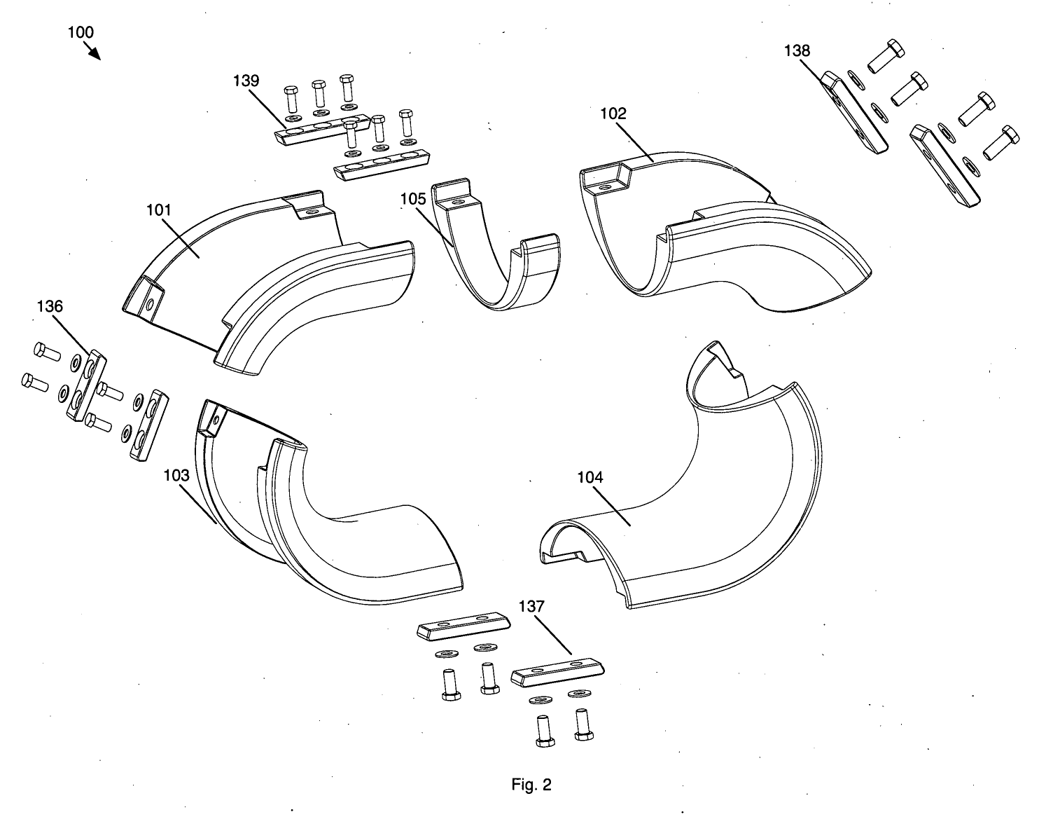

FIG. 2 illustrates that the Removable Chock Insert Liner Assembly 100 may further incorporate in some preferred embodiments a First Set of Angled Connection Bars 136, a Second Set of Angled Connection Bars 137, a Third Set of Angled Connection Bars 138, and a Bridge Set of Angled Connection Bars 139.

The First Set of Angled Connection Bars 136 is disposed in the α first distal end slots 116 of the α Insert Panel 101 and the Δ first distal end slots 128 of the Δ Insert Panel 103.

The Second Set of Angled Connection Bars 137 is disposed in the Ω first distal end slots 134 of the Ω Insert Panel 104 and the Δ second distal end slots 129 of the Δ Insert Panel 103.

The Third Set of Angled Connection Bars 138 is disposed in the Ω second distal end slots 135 of the Ω Insert Panel 104 and the β second distal end slots 123 of the β Insert Panel 102.

The Bridge Set of Angled Connection Bars 139 is disposed in the α second distal end slots 117 of the α Insert Panel 101, the first slot 110 and second slot 111 of the Bridge Member 105, and the β first distal end slots 122 of the β Insert Panel 102.

Each of the bars which constitute the aforementioned set of angled connection bars may be comprised of a corrosion-resistant metal in some preferred embodiments. The corrosion-resistant metal may, be either cast, forged, or stamped. Moreover, some bars 151 may include two orifices through which fasteners may be affixed. Other bars 152 may include three orifices through which fasteners may be affixed.

The bars 151, 152 are tapered at the distal ends at around 20° in some preferred embodiments. As the bars 151, 152 are tightened, the tapered ends enable the bars 151, 152 to apply outward force.

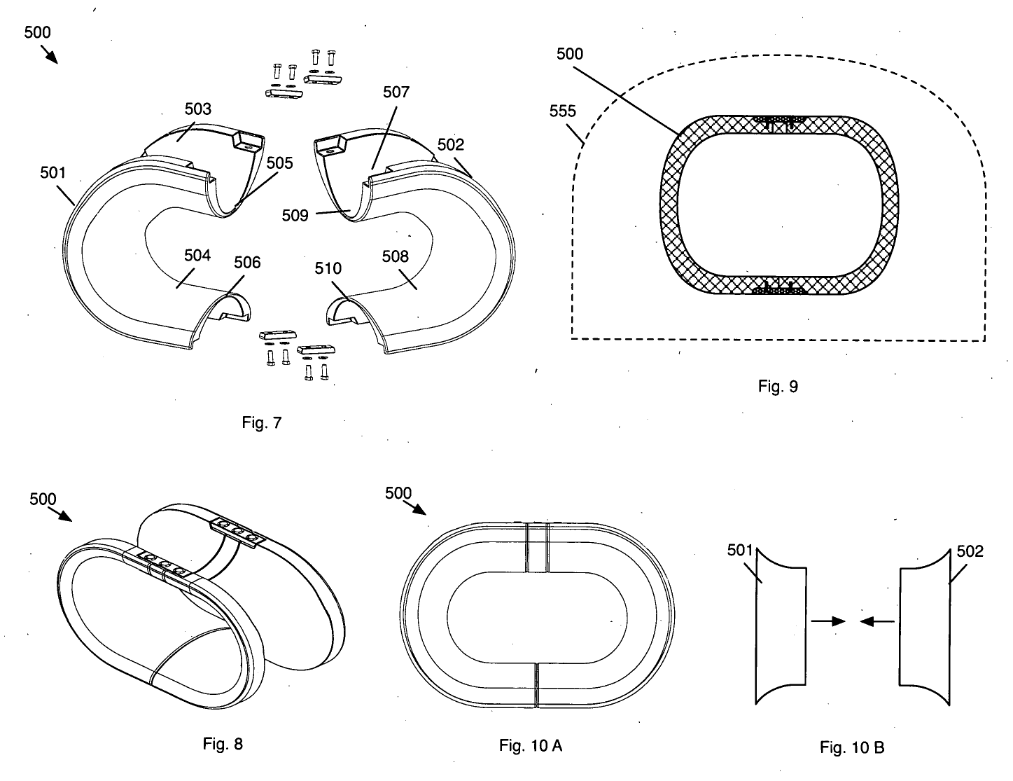

FIG. 7 illustrates another preferred embodiment of the present invention. A Chock Insert Liner Assembly 500 for use with chocks 555 for the purpose of lining a surface of a chock 555 includes a first panel 501 and a second panel 502. The first panel 501 and the second panel 502 are shaped at their respective distal ends to interface with each other. It should be understood that the location of the seam or interface between the first panel 501 and second panel 502 is of no consequence and can vary in other preferred embodiments. For instance, FIG. 10B illustrates that the seam may be found longitudinally between the first panel 501 and a second panel 502. In some preferred embodiments the first panel 501 and second panel 502 are coated with a low friction and anti-corrosion coating.

The first panel 501 comprises a top surface 503, a bottom surface 504, a primary distal end 505 and a secondary distal end 506. The top surface 503 of the first panel 501 is shaped to conform to a chock 555.

The second panel 502 comprises an upper side 507, a lower side 508, a second panel first distal end 509 and a second panel second distal end 510. The lower side 508 of the second panel 502 is shaped to conform to a chock 555. The primary distal end 505 of the first panel 501 interfaces with the second panel first distal end 509 of the second panel 502. The secondary distal end 506 of the first panel 501 interfaces with the second panel second distal end 510 of the second panel 502.

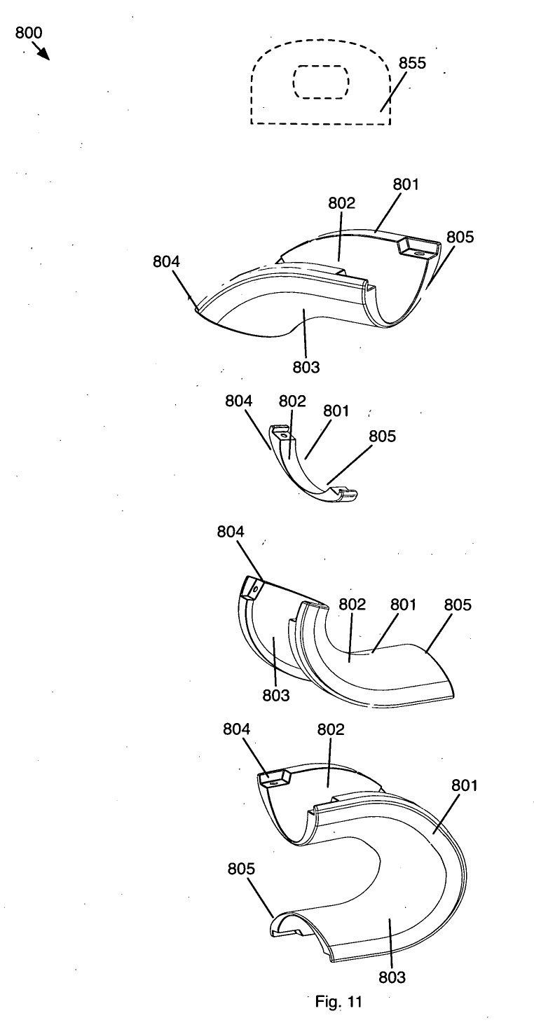

FIG. 11 illustrates A Chock Liner Assembly 800 for use with chocks including a plurality of modular panels 801. This modular designed embodiment is illustrated to emphasize that the Chock Liner Assembly 800 can be comprised of a plurality of modular components. Various sized modular components can be used in concert with each other to achieve a complete lining of the chock. Therefore, the Chock Liner Assembly 800 may be comprised of two, three, four, or many separate modular components collectively used to cover the surface opening of a chock.

Each modular panel 801 is sized and shaped to cooperate with the other modular panels 801 to cover the opening of a chock 855. Each modular panel 801 has a primary surface 802 and a secondary surface 803, a first mating end 804 and a second mating end 805.

The first mating end 804 of each modular panel 801 is interfaced with the second mating end 805 of each modular panel 801. In some preferred embodiments the modular panels 801 are coated with a low friction and anti-corrosion coating.

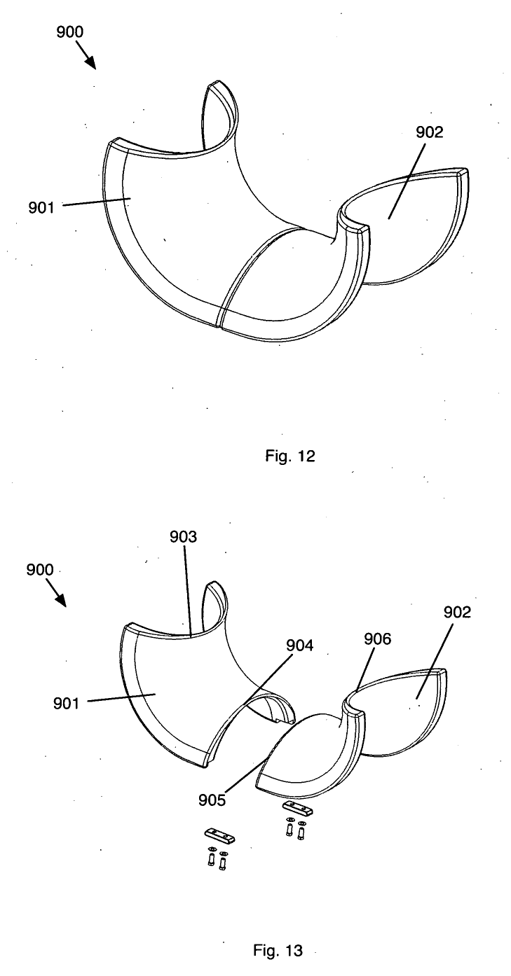

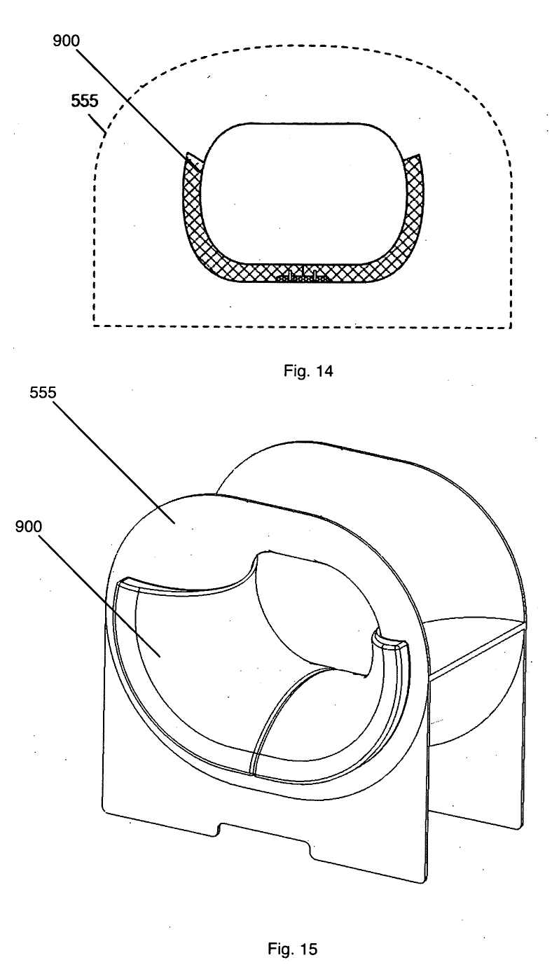

FIGS. 12-15 illustrate another preferred embodiment of the present invention. In this particular embodiment, a Partial Lining Assembly 900 includes a First Lining Panel 901 and a Second Lining panel 902. As illustrated, the Partial Lining Assembly 900 may not necessarily cover the entire surface area of the opening of a Chock 555. The First Lining Panel 901 comprises a First End 903, and a Second End 904. The Second Lining panel 902 comprises a Mating End 905 and an Opposite End 906. The Second End 904 of the First Lining Panel 901 is interfaced with the Mating End 905 of the Second Lining panel 902.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Removable Chock Insert Liner Assembly to be affixed to a chock for the purpose of lining a surface of a chock comprising:
an α Insert Panel, a β Insert Panel, a Δ Insert Panel, an Ω Insert Panel, and a Bridge Member;
the Bridge Member has an upper bridge surface, a lower bridge surface, an anterior end, a posterior end, a first slot and a second slot;
the α Insert Panel comprises an α upper surface, a α lower surface, an α first distal end, a α second distal end, an α pair of α first distal end slots, and a pair of α second distal end slots;
the β Insert Panel comprises a β upper surface, a β lower surface, a β first distal end, a β second distal end, a pair of β first distal end slots, and a pair of β second distal end slots;
the Δ Insert Panel comprises a Δ upper surface, a Δ lower surface, a Δ first distal end, a Δ second distal end, a pair of Δ first distal end slots, and a pair of Δ second distal end slots;
the Ω Insert Panel comprises an Ω upper surface, an Ω lower surface, an Ω first distal end, an Ω second distal end, a pair of Ω first distal end slots, and a pair of Ω second distal end slots;
the α Insert Panel is connected with the Δ Insert Panel at the α first distal end of the α Insert Panel and the Δ second distal end of the Δ Insert Panel;
the Δ Insert Panel is connected with the Ω Insert Panel at the Δ first distal end of the Δ Insert Panel and the Ω second distal end of the Ω Insert Panel;
the Ω Insert Panel is connected with the β Insert Panel at the Ω first distal end of Ω Insert Panel and the β second distal end of the β Insert Panel;
the α Insert Panel is connected with the Bridge Member at the anterior end;
the β Insert Panel is connected with the Bridge Member at the posterior end.

2. The Removable Chock Insert Liner Assembly of claim 1 further comprising a First Set of Angled Connection Bars, a Second Set of Angled Connection Bars, a Third Set of Angled Connection Bars, and a Fourth Set of Angled Connection Bars;
the First Set of Angled Connection Bars is disposed in the α first distal end slots of the α Insert Panel and the Δ first distal end slots of the Δ Insert Panel;
the Second Set of Angled Connection Bars is disposed in the Ω first distal end slots of the Ω Insert Panel and the Δ second distal end slots of the Δ Insert Panel;
the Third Set of Angled Connection Bars is disposed in the Ω second distal end slots of the Ω Insert Panel and the β second distal end slots of the β Insert Panel;
the Fourth Set of Angled Connection Bars is disposed in the α second distal end slots of the α Insert Panel, the first slot and second slots of the Bridge Member, and the β first distal end slots of the β Insert Panel.

3. The Removable Chock Insert Liner Assembly of claim 1 wherein the upper surface of the α Insert Panel is shaped to conform to a chock.

4. The Removable Chock Insert Liner Assembly of claim 1 wherein the upper surface of the β Insert Panel is shaped to conform to a chock.

5. The Removable Chock Insert Liner Assembly of claim 1 wherein the lower surface of the Δ Insert Panel is shaped to conform to a chock.

6. The Removable Chock Insert Liner Assembly of claim 1 wherein the lower surface of the Ω Insert Panel is shaped to conform to a chock.

7. The Removable Chock Insert Liner Assembly of claim 6 wherein the lower surface of the α Insert Panel is coated with a low friction and anti-corrosion coating.

8. The Removable Chock Insert Liner Assembly of claim 6 wherein the lower surface of the β Insert Panel is coated with a low friction and anti-corrosion coating.

9. The Removable Chock Insert Liner Assembly of claim 6 wherein the upper surface of the Δ Insert Panel is coated with a low friction and anti-corrosion coating.

10. The Removable Chock Insert Liner Assembly of claim 6 wherein the upper surface of the Ω Insert Panel is coated with a low friction and anti-corrosion coating.

11. The Removable Chock Insert Liner Assembly of claim 6 wherein the α Insert Panel, a β Insert Panel, a Δ Insert Panel, an Ω Insert Panel, and the Bridge Member are coated with an anti-corrosion coating.

12. A Chock Insert Liner Assembly for use with chocks for the purpose of lining a surface of a chock comprising:
A first panel and a second panel;
The first panel and the second panel are shaped at their respective distal ends to interface with each other;
The first panel comprises a top surface, a bottom surface, a primary distal end and a secondary distal end;
The second panel comprises an upper side, a lower side, a second panel first distal end and a second panel second distal end;
The primary distal end of the first panel interfaces with the second panel first distal end;
The secondary distal end of the first panel interfaces with the second panel second distal end.

13. The Chock Insert Liner Assembly of claim 12 wherein the top surface of the first panel is shaped to conform to a chock.

14. The Chock Insert Liner Assembly of claim 12 wherein the lower side of the second panel is shaped to conform to a chock.

15. The Chock Insert Liner Assembly of claim 12 wherein the first panel is coated with a low friction and anti-corrosion coating.

16. The Chock Insert Liner Assembly of claim 12 wherein the second panel is coated with a low friction and anti-corrosion coating.

17. A Chock Liner Assembly for use with chocks comprising:
A plurality of modular panels;
Each modular panel is sized and shaped to cooperate with the other modular panels to cover the opening of a chock;
Each modular panel has a primary surface and a secondary surface, a first mating end and a second mating end;
The first mating end of each modular panel is interfaced with the second mating end of each modular panel.

18. The Chock Liner Assembly of claim 17 wherein the secondary surface is shaped to conform to the surface of a chock.

19. The Chock Liner Assembly of claim 17 wherein each modular panel is coated with a low friction and anti-corrosion coating.
